(19) United States
(12) Patent Application Publication
(10) Pub. No.: US 2015/0364970 A1
(43) Pub. Date: Dec. 17, 2015

(54) AC MOTOR WITH REDUCTION MECHANISM

(71) Applicant: National Cheng Kung University, Tainan City (TW)

(72) Inventors: Hong-sen Yan, Tainan City (TW); Yi-chang Wu, Tainan City (TW); Jian-liang Lin, Tainan City (TW); Kuan-chen Chen, Tainan City (TW)

(73) Assignee: National Cheng Kung University, Tainan City (TW)

(21) Appl. No.: 14/304,956

(22) Filed: Jun. 15, 2014

(51) Int. Cl. H02K 7/116; H02K 19/02

(52) U.S. Cl. CPC H02K 7/116; H02K 19/02

(57) ABSTRACT

An AC motor with a reduction mechanism is disclosed. The AC motor has a stator unit, a rotor unit, and a reduction transmission unit. An axial space of the AC motor can be substantially reduced by providing the reduction transmission unit directly built in the AC motor, and a path of the power transmission between the rotor unit and an output shaft can be reduced, so that the loss of the mechanical energy can be lowered.

### FIELD OF THE INVENTION

The present invention relates to an alternating current (AC) motor, and more particularly to an AC motor with a reduction mechanism.

### BACKGROUND OF THE INVENTION

In industry, motors generally are used for generating power, and gear reducers are used as a means for transmission shifting. A motor combines with a gear reducer for improving a torque of the motor or reducing the speed. The motor and the gear reducer must be matched based on work load, working speed, and maintaining motor operation at the most efficient operating point, in order to achieve better operating characteristics for the motor.

For example, FIG. 1 is a perspective view of a traditional AC motor 11 and a traditional gear reducer 12. The traditional AC motor 11 and the traditional gear reducer 12 are separated, and connected by the Intermediary mechanical components. Such as couplings or power-transmitting elements, are further employed for transmitting motion and/or power from the electric motor to the gear reducer. An output shaft 111 of the motor 11 is engaged with an input member 121 of the gear reducer 12 so that the output torque of the motor 11 is delivered to the gear reducer 12.

However, it suffers from significant disadvantages, such as the use of couplings or power-transmitting elements, which is the primary failure source and increases the maintenance complexity and manufacturing costs. The additional mechanical loss caused by the friction of intermediary components results in undesirable low efficiency. In addition, the output torque of the motor 11 is delivered to the gear reducer 12 through the coupling, and a path of the power transmission between the motor 11 and the gear reducer 12 is longer, and a friction of the coupling losses additional mechanical energy, resulting in lower efficiency. The motor 11 and the gear reducer 12 are independently design and manufactured. The transmission components, racks, and lock parts are provided to combine the motor 11 and the gear reducer 12, which increases manufacturing and maintenance costs, so that the accuracy of the system is reduced. Moreover, the volume of the motor 11 and the gear reducer 12 is large and difficult to change, so that the installation space can't be planted.

Therefore, improved an AC motor with a reduction mechanism needs to be provided to solve the problems of the prior art.

### SUMMARY OF THE INVENTION

A primary object of the present invention is to provide an AC motor which integrates a reduction transmission unit and an AC motor, so that the reduction transmission unit can be installed in the AC motor as a reduction mechanism, and an axial space of the AC motor can be substantially reduced.

A secondary object of the present invention is to provide an AC motor which provides a reduction transmission unit installed in the AC motor, so that a path of the power transmission between the rotor unit and an output shaft can be reduced, and the loss of the mechanical energy can be lowered.

To achieve the above objects, the present invention provides an AC motor which comprises: a stator unit having a stator body, a plurality of stator salient poles disposed on an inner surface of the stator body, and a plurality of stator coils wound on the stator salient poles, respectively; a rotor unit having a rotor body, a plurality of rotor salient poles formed on an outer surface of the rotor body, a plurality of outer tooth portions formed on an outer surface of the rotor salient poles, and a plurality of rotor coils wound on the rotor salient poles, respectively, for inducting with the stator salient poles; and a reduction transmission unit having at least one transmission gear engaged with the outer tooth portions of the rotor unit, and an output shaft actuated to rotate by the transmission gear.

In one embodiment of the present invention, the reduction transmission unit further comprises: a first transmission gear engaged with the outer tooth portions of the rotor unit; a second transmission gear, wherein the first and second transmission gears are coaxially rotated, and a tooth number of the second transmission gear is less than that of the first transmission gear; and an output gear engaged with the second transmission gear and installed on the output shaft.

In one embodiment of the present invention, the AC motor further comprises: a case covered on the stator unit, the rotor unit and the reduction transmission unit, wherein the case has a base and a cover combined with the base, the stator body is disposed on the base, and the output shaft is extended out of the cover.

In one embodiment of the present invention, the case further comprises a recess formed in the base, and the stator body is embedded in the recess.

To achieve the above objects, the present invention provides an AC motor which comprises: a stator unit having a stator body, a plurality of outer tooth portions formed on an outer surface of the stator body, a plurality of stator salient poles disposed on an inner surface of the stator body, and a plurality of stator coils wound on the stator salient poles, respectively; a rotor unit having a rotor body, a plurality of rotor salient poles formed on the rotor body, and a plurality of rotor coils wound on the rotor salient poles, respectively, for inducting with the stator salient poles; and a reduction transmission unit having at least one transmission gear engaged with the outer tooth portions of the stator unit, and an output shaft actuated to rotate by the transmission gear.

In one embodiment of the present invention, the reduction transmission unit further comprises: an actuation arm having one end mounted on the rotor body and actuated to rotate by the rotor body; a first transmission gear engaged with the outer tooth portions of the stator unit; a second transmission gear, wherein a tooth number of the second transmission gear is less than that of the first transmission gear, and the first and second transmission gears are pivotally connected to and coaxially installed on the other end of the actuation arm; and an output gear engaged with the second transmission gear and installed on the output shaft.

In one embodiment of the present invention, the AC motor further comprises: a case covered on the stator unit, the rotor unit and the reduction gear unit, wherein the case has a base and a cover combined with the base, the stator body is disposed in the base, and the output shaft is extended out of the cover.

In one embodiment of the present invention, the base comprises: an assembly piece; a projection formed on the assembly piece; and a shell installed between the assembly piece and the cover for accommodating the stator unit, the rotor unit and the reduction transmission unit, wherein the stator body is installed on the projection.

As described above, the reduction transmission unit can be installed in the AC motor by integrating with the reduction transmission unit and the AC motor as a reduction mechanism, so that the axial space of the AC motor can be substantially reduced, the path of the power transmission between the rotor unit and an output shaft can be reduced, and the loss of the mechanical energy can be lowered.

### DESCRIPTION OF THE DRAWINGS

FIG. 1 is a perspective view of a traditional AC motor and a traditional gear reducer;

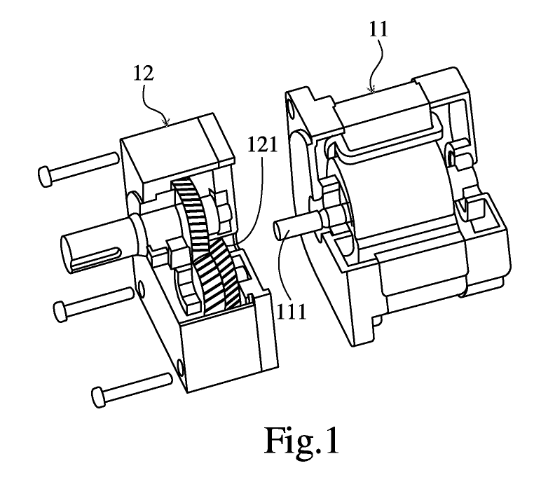

FIG. 2 is an exploded perspective view of the AC motor with reduction according to a first preferred embodiment of the present invention;

FIG. 3 is a cross-sectional view of the AC motor with reduction according to a first preferred embodiment of the present invention;

FIG. 4 is an exploded perspective view of the AC motor with reduction according to a second preferred embodiment of the present invention; and

FIG. 5 is a cross-sectional view of the AC motor with reduction according to a second preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, and etc., are only directions by referring to the accompanying drawings, and thus the used directional terms are used to describe and understand the present invention, but the present invention is not limited thereto.

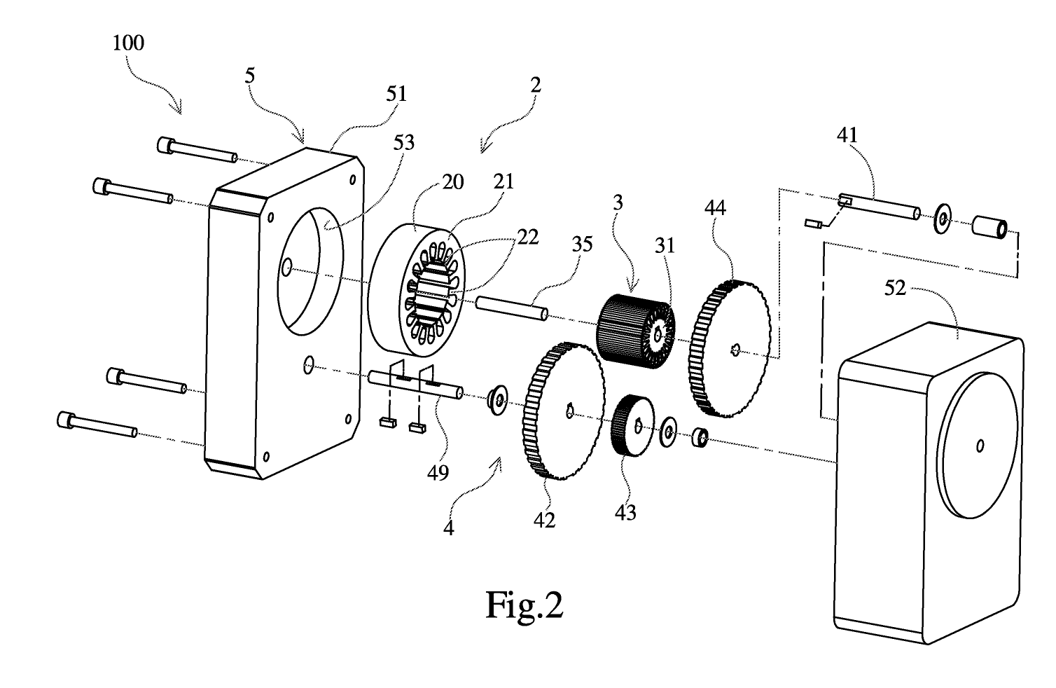

Referring now to FIG. 2, an AC motor 100 according to a first preferred embodiment of the present invention is illustrated, and comprises a stator unit 2, a rotor unit 3, a reduction transmission unit 4 and a case 5. The stator unit 2, the rotor unit 3 and the reduction transmission unit 4 are integrated in the case 5 of the motor 100. The detailed structure of each component, assembly relationships and principle of operation in the present invention will be described in detail thereinafter.

Referring still to FIG. 2, the case 5 is covered on the stator unit 2, the rotor unit 3 and the reduction transmission unit 4, wherein the case 5 has a base 51, a cover 52 and a recess 53. The recess 53 is round and formed in the base 51. The cover 52 and the base 51 are combined by fastening bolts.

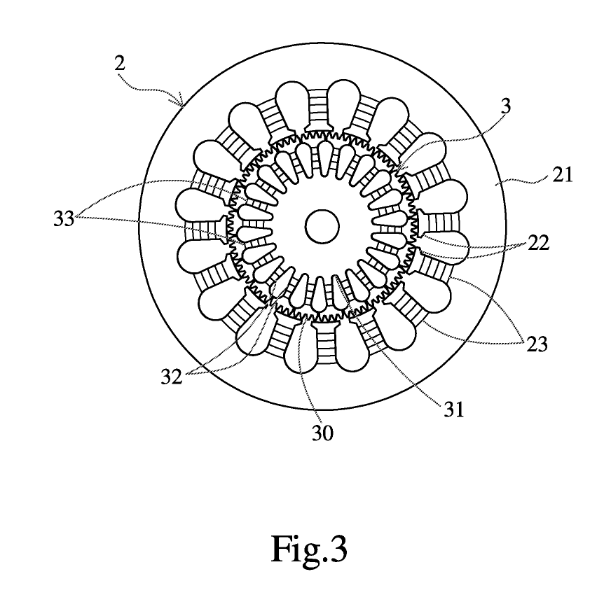

Referring now to FIGS. 2 and 3, the stator unit 2 has a stator body 21, a plurality of stator salient poles 22 and a plurality of stator coils 23. The stator body 21 is disposed on the base 51 and embedded in the recess 53, the stator salient poles 22 are disposed on an inner surface of the stator body 21, and the stator coils 23 are wound on the stator salient poles 22, respectively.

Referring still to FIGS. 2 and 3, the rotor unit 3 has a rotor body 31, a plurality of rotor salient poles 32, a plurality of rotor coils 33, a rotor shaft 35 and a plurality of outer tooth portions 30. The rotor body 31 is connected with the rotor shaft 35, the rotor salient poles 32 are formed an outer surface of the rotor body 31, and the rotor coils 33 are wound on the rotor salient poles 32, respectively. For inducting with the stator salient poles 22, the rotor shaft 35 is disposed on the base 51 by combing with a bearing and pivoted on a center of the recess 53, and the outer tooth portions 30 are formed on the outer surface of the rotor salient poles 32.

Referring still to FIGS. 2 and 3, the reduction transmission unit 4 has an output shaft 41, a first transmission gear 42, a second transmission gear 43, an output gear 44 and a transmission shaft 49. The output shaft 41 is extended out of the cover 52, the first transmission gear 42 engaged with the outer tooth portions 30 of the rotor unit 3, and the first and second transmission gears 42, 43 are connected on the transmission shaft 49, wherein the first and second transmission gears 42, 43 are coaxially rotated, and a tooth number of the second transmission gear 43 is less than that of the first transmission gear 42. The transmission shaft 49 is connected on the base 51. In addition, the output gear 44 is engaged with the second transmission gear 43 and connected on the output shaft 41, so that the output shaft 41 and output gear 44 can be rotated by the first and second transmission gears 42, 43.

Referring still to FIGS. 2 and 3, as described above, when the stator coils 23 and the rotor coils 33 of the AC motor 100 are conducted, the rotor body 31 is rotated by mutual exclusion, so that the outer tooth portions 30 are rotated by the first transmission gear 42. The first and second transmission gears 42, 43 are coaxially rotated and causing the output gear 44 to be rotated, so that the output shaft 41 is synchronously rotated, and the output power of the AC motor 100 can be reduced.

As described above, the reduction transmission unit 4 and the AC motor 100 are integrated, so that the reduction transmission unit can be installed in the case 5 as a reduction mechanism. The transmission components, the racks, and the lock parts of prior art do not need to be used, so that the structure of the AC motor 100 is lightweight and easily maintained. In addition, the stator unit 2, the rotor unit 3, and the reduction transmission unit 4 are combined (e.g. the outer tooth portions 30 are engaged with the first transmission gear 42), so that the elements can be simplified and the axial space of the AC motor can be substantially reduced. Moreover, the path of the power transmission between the rotor unit 3 and the output shaft 41 can be reduced, and the loss of the mechanical energy can be lowered.

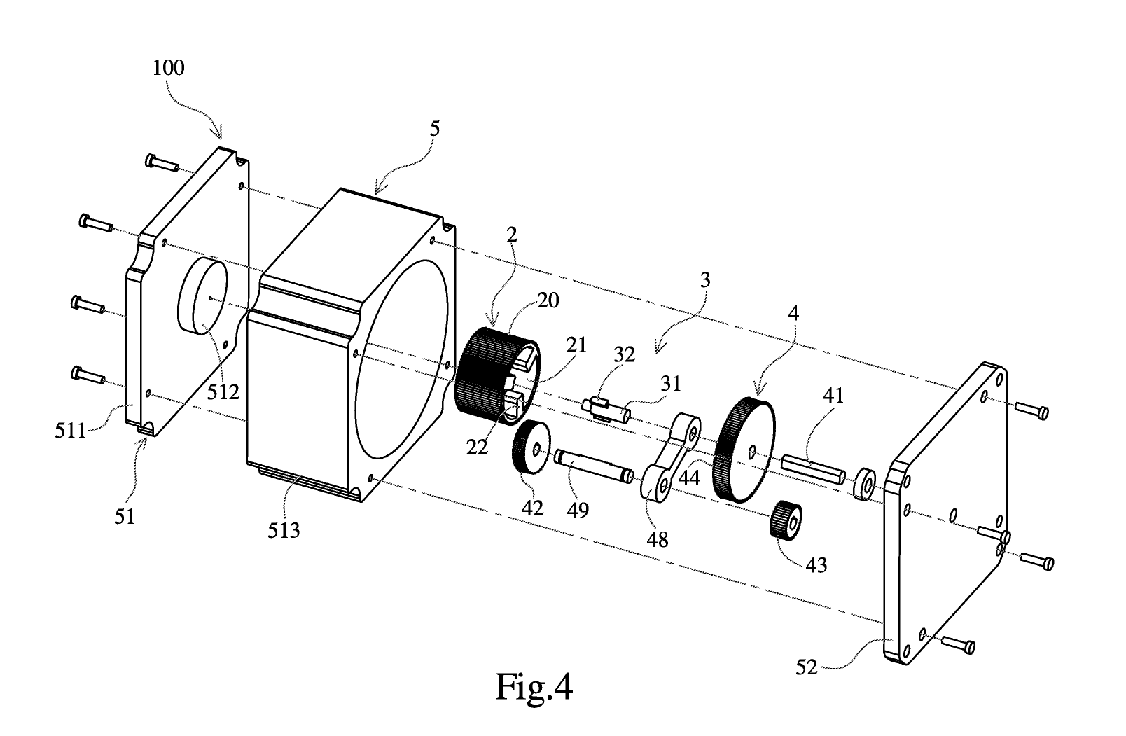

Referring now to FIG. 4, an AC motor 100 according to a second embodiment of the present invention is illustrated, and is similar to the first embodiment, which comprises a stator unit 2, a rotor unit 3, a reduction transmission unit 4 and a case 5, wherein the stator unit 2, the rotor unit 3 and the reduction transmission unit 4 are integrated in the case 5 of the motor 100, so that the second embodiment uses terms or numerals similar to the first embodiment. As shown, the difference of the second embodiment is that the reduction transmission unit 4 is transmitted by the planetary gears. The detailed structure of each component, assembly relationships and principles of operation in the present invention will be described in detail hereinafter.

Referring still to FIG. 4, the case 5 is covered on the stator unit 2, the rotor unit 3 and the reduction gear unit 4, wherein the case 5 has a base 51 and a cover 52. The base 51 comprises an assembly piece 511, a projection 512 and a shell 513. The projection 512 formed on the assembly piece 511, and the shell 513 is combined between the assembly piece 511 and cover 52 by fastening bolts for accommodating the stator unit 2, the rotor unit 3 and the reduction transmission unit 4.

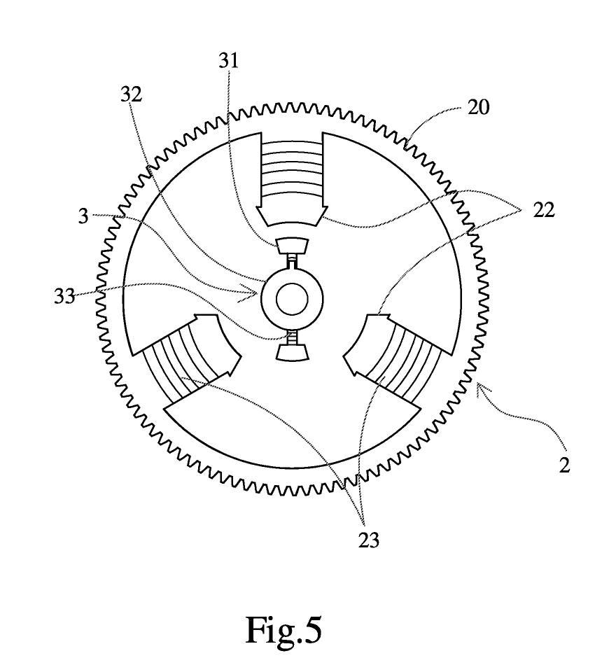

Referring now to FIGS. 4 and 5, the stator unit 2 has a stator body 21, a plurality of stator salient poles 22, a plurality of stator coils 23 and a plurality of outer tooth portions 20. The stator body 21 is disposed on the base 51 and embedded on the projection 512, the outer tooth portions 22 are formed on an outer surface of the stator body 21, the stator salient poles 23 are disposed on an inner surface of the stator body 21, and the stator coils 24 are wound on the stator salient poles 23, respectively.

Referring still to FIGS. 4 and 5, the rotor unit 3 has a rotor body 31, a plurality of rotor salient poles 32 and a plurality of rotor coils 33. The rotor salient poles 32 are spindle-shaped and formed on the rotor body 31. The rotor coils 33 are wound on the rotor salient poles 32, respectively, for inducting with the stator salient poles 23.

Referring still to FIGS. 4 and 5, the reduction transmission unit 4 has a output shaft 41, a first transmission gear 42, a second transmission gear 43, an output gear 44, an actuation arm 48 and a transmission shaft 49, wherein the actuation arm has one end mounted on the rotor body 31 and actuated to rotate by the rotor body 31. The first transmission gear 42 is engaged with the outer tooth portions 22 of the stator unit 2, wherein a tooth number of the second transmission gear 43 is less than that of the first transmission gear 42, and the first and second transmission gears 42, 43 are pivotally connected to and coaxially installed on the other end of the actuation arm 49, and the center of the actuation arm 49 is pivotally connected on the other end of the actuation arm 48, so that the first and second transmission gears 42, 43 can be rotated by the actuation arm 48. In addition, the output gear 44 is engaged with the second transmission gear 43 and installed on the output shaft 41, and the output shaft 41 is extended out of the cover 5.

Referring still to FIGS. 4 and 5, as described above, when the stator coils 23 and the rotor coils 33 of the AC motor 100 are conducted, the rotor body 31 is rotated by mutual exclusion, so that the first and second transmission gears 42, 43 are in synchronous revolution by the actuation arm 48. The first transmission gear 42 is engaged with the outer tooth portions 22 of the stator unit 2, and the outer tooth portions 22 is fixed so that the first transmission gear 42 is rotated. The second transmission gear 43 is coaxially rotated by the first transmission gear 42 through the actuation arm 49, and the output gear 44 is actuated to rotate by the second transmission gear 43, so that the output shaft 41 is synchronously rotated and the output power of the AC motor 100 can be reduced. In addition, the first and second transmission gears 42, 43 are located at two sides of the actuation arm 48 respectively, so that the revolution and rotation can be balanced in two planetary gears, and the actuation arm 48 will not be broken by focused torque.

By such designs, the reduction transmission unit 4 transmitted by the planetary gears, so that the output shaft 41 and the rotor body 31 are coaxially rotated, homeostatic characteristics can be correct.

As described above, the reduction transmission unit 4 and the AC motor 100 of the present invention are integrated, so that the reduction transmission unit 4 can be installed in the case 5 as a reduction mechanism. Thus, the transmission components, the racks and the lock parts of the prior art do not need to be further used, so that the structure of the AC motor 100 of the present invention is lightweight and easily maintained. In addition, the stator unit 2, the rotor unit 3 and the reduction transmission unit 4 of the present invention are combined (e.g. the outer tooth portions 30 are engaged with the first transmission gear 42), so that the elements can be simplified and the axial space of the AC motor can be substantially reduced. Moreover, the path of the power transmission between the rotor unit 3 and the output shaft 41 can be reduced, and the loss of the mechanical energy can be lowered.

The present invention has been described with preferred embodiments thereof, and it is understood that many changes and modifications to the described embodiments can be carried out without departing from the scope and the spirit of the invention that is intended to be limited only by the appended claims.

What is claimed is:

1. An AC motor with a reduction mechanism, comprising:
a stator unit having a stator body, a plurality of stator salient poles disposed on an inner surface of the stator body, and a plurality of stator coils wound on the stator salient poles, respectively;
a rotor unit having a rotor body, a plurality of rotor salient poles formed on an outer surface of the rotor body, a plurality of outer tooth portions formed on an outer surface of the rotor salient poles, and a plurality of rotor coils wound on the rotor salient poles, respectively, for inducting with the stator salient poles; and
a reduction transmission unit having at least one transmission gear engaged with the outer tooth portions of the rotor unit, and an output shaft actuated to rotate by the transmission gear.

2. The AC motor according to claim 1, wherein the reduction transmission unit further comprises:
a first transmission gear engaged with the outer tooth portions of the rotor unit;
a second transmission gear, wherein the first and second transmission gears are coaxially rotated, and a tooth number of the second transmission gear is less than that of the first transmission gear; and
an output gear engaged with the second transmission gear and installed on the output shaft.

3. The AC motor according to claim 1, wherein the AC motor further comprises:
a case covered on the stator unit, the rotor unit, and the reduction transmission unit, wherein the case has a base and a cover combined with the base, the stator body is disposed on the base, and the output shaft is extended out of the cover.

4. The AC motor according to claim 3, wherein the case further comprises a recess formed in the base, and the stator body is embedded in the recess.

5. An AC motor with a reduction mechanism, comprising:
a stator unit having a stator body, a plurality of outer tooth portions formed on an outer surface of the stator body, a plurality of stator salient poles disposed on an inner surface of the stator body, and a plurality of stator coils wound on the stator salient poles, respectively;
a rotor unit having a rotor body, a plurality of rotor salient poles formed on the rotor body, and a plurality of rotor coils wound on the rotor salient poles, respectively, for inducting with the stator salient poles; and
a reduction transmission unit having at least one transmission gear engaged with the outer tooth portions of the stator unit, and an output shaft actuated to rotate by the transmission gear.

6. The AC motor according to claim 5, wherein the reduction transmission unit further comprises:
an actuation arm having one end mounted on the rotor body and actuated to rotate by the rotor body;
a first transmission gear engaged with the outer tooth portions of the stator unit;
a second transmission gear, wherein a tooth number of the second transmission gear is less than that of the first transmission gear, and the first and second transmission gears are pivotally connected to and coaxially installed on the other end of the actuation arm; and
an output gear engaged with the second transmission gear and installed on the output shaft.

7. The AC motor according to claim 5, wherein the AC motor further comprises:
a case covered on the stator unit, the rotor unit, and the reduction gear unit, wherein the case has a base and a cover combined with the base, the stator body is disposed in the base, and the output shaft is extended out of the cover.

8. The AC motor according to claim 7, wherein the base comprises:
an assembly piece;
a projection formed on the assembly piece; and
a shell installed between the assembly piece and the cover for accommodating the stator unit, the rotor unit, and the reduction transmission unit, wherein the stator body is installed on the projection.
